(19) United States
(12) Patent Application Publication
(10) Pub. No.: US 2007/0094318 A1
(43) Pub. Date: Apr. 26, 2007

(54) Method and system for hardware efficient systematic approximation of square functions for communication systems

(76) Inventor: Christian Lutkemeyer, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/257,326

(22) Filed: Oct. 24, 2005

(51) Int. Cl. G06F 7/38

(52) U.S. Cl. 708/290

(57) ABSTRACT

Certain aspects of a method and system for implementing approximation of a square function may comprise generating an output value by subtracting an absolute value of a first received input and a second received input. The generated output may be left shifted so as to generate a left shifted value. An output may be generated by left shifting by a plurality of bits, a sum of the generated left shifted value and the absolute value of the first received input. The second received input S may be determined by S=2^{└log}^{₂}^{X┘}, where X is the first received input. The plurality of bits used for left shifting during generation of the output may be determined by log₂(S). A leading ‘1’ in the first received input may be detected in order to generate the second received input.

### CROSS-REFERENCE TO RELATED APPLICATIONS/INCORPORATION BY REFERENCE

Not applicable.

### FIELD OF THE INVENTION

Certain embodiments of the invention relate to processing of signals in a communication system. More specifically, certain embodiments of the invention relate to a method and system for hardware efficient systematic approximation of square functions for communication systems.

### BACKGROUND OF THE INVENTION

Digital signal processing is an area of science and engineering that has developed rapidly over the last couple of decades. This rapid development is a result of the significant advances in digital computer technology and integrated circuit fabrication. The digital computers and associated digital hardware in the past were general-purpose non-real time devices that handled scientific computations and business applications. The rapid developments in integrated circuit technology, starting with medium scale integration (MSI) and progressing to large scale integration, and very-large scale integration (VLSI) of electronic circuits has spurred the development of powerful, smaller faster, and cheaper digital computers and special purpose digital hardware. These inexpensive and relatively fast digital circuits have made it possible to construct highly sophisticated digital systems capable of performing complex digital signal processing functions and tasks, which may be usually difficult and expensive to be performed by analog circuitry or analog processing systems. Hence many of the signal processing tasks that were conventionally performed by analog means may be realized by less expensive and often more reliable digital hardware.

Digital signal processing may be applied in practical systems covering a broad range of disciplines. For example, the digital signal processing techniques may be applied in speech processing and signal transmission on telephone channels, in image processing and transmission, and in a vast variety of other applications. DSPs are also utilized for execution of algorithms such as decoding algorithms. One such algorithm is the Viterbi algorithm.

The Viterbi algorithm may be utilized to perform the maximum likelihood decoding of convolutional codes. When a signal has no memory, a symbol-by-symbol detector may be utilized to minimize the probability of a symbol error. When a transmitted signal has memory, the signals transmitted in successive symbol intervals are interdependent. An optimum detector for a signal with memory may base its decisions on observation of a sequence of received signals over successive signal intervals. A maximum likelihood sequence detection algorithm may be adapted to search for the minimum Euclidean distance path through a trellis that characterizes the memory in the transmitted signal.

Square functions are commonly used in communication systems, for example, to determine Euclidean distances in branch metric calculation of Viterbi algorithms and for maximum likelihood estimation of information filters. The piecewise linear approximation of a function, for example, a square function may be obtained by dividing the maximum input interval of the function of the curve into a suitable number of sub-intervals. The function of the curve may be approximated by drawing a line between each of the divided sub-intervals. The implementation of a square function in hardware may be expensive, as it requires a multiplier. Other implementations of the square function in hardware have resulted in less efficient, less systematic architectures with higher system degradation.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for hardware efficient systematic approximation of square functions for communication systems, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a graph illustrating a parabola for a function y=x² and a piecewise linear approximation of the parabola for the function y=x² that may be utilized in connection with an embodiment of the invention.

FIG. 2 is a graph illustrating the positive half of the parabola for the function y=x² and the positive half of the piecewise linear approximation of the parabola for the function y=x² that may be utilized in connection with an embodiment of the invention.

FIG. 3 is a graph illustrating the relative error of approximation between the parabola for the function y=x² and a piecewise linear approximation of the parabola for the function y=x² that may be utilized in connection with an embodiment of the invention.

FIG. 4a is a block diagram illustrating an exemplary receiver comprising a Viterbi decoder that may utilize square function approximation, in accordance with an embodiment of the invention.

FIG. 4b is a block diagram illustrating an implementation of the piecewise linear approximation of the parabola for the function y=x², in accordance with an embodiment of the invention.

FIG. 5a is a block diagram illustrating implementation of the function y=x² that may be utilized in connection with an embodiment of the invention.

FIG. 5b is a block diagram illustrating implementation of an approximation of the function y=x², in accordance with an embodiment of the invention.

### DETAILED DESCRIPTION OF THE INVENTION

Certain aspects of a method and system for implementing approximation of a square function may comprise generating an output value by subtracting an absolute value of a first received input and a second received input. The generated output may be left shifted so as to generate a left shifted value. An output may be generated by left shifting by a plurality of bits, a sum of the generated left shifted value and the absolute value of the first received input. The second received input S may be determined by S=2^{└log}^{₂}^{X┘}, where X is the first received input. The plurality of bits used for left shifting during generation of the output may be determined by log₂(S). A leading ‘1’ in the first received input may be detected in order to generate the second received input. Euclidean distances in Viterbi branch metric calculation or image classification may utilize the generated output.

Square functions are commonly utilized in branch metric calculation of Viterbi algorithms and for mean likelihood estimation of information filters. With regard to Viterbi algorithms, a square approximation block may calculate the Euclidean distance for soft-decision decoding between receive code words and a plurality of transmitted codewords.

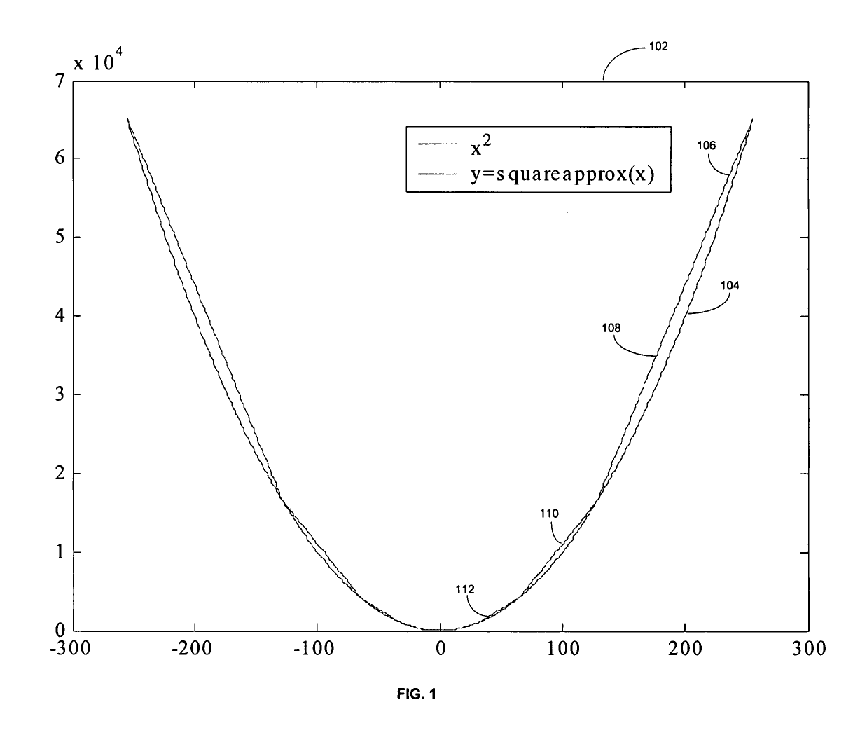

FIG. 1 is a graph 102 illustrating a parabola 104 for a function y=x² and a piecewise linear approximation of the parabola 106 for the function y=x² that may be utilized in connection with an embodiment of the invention. A maximum input range may comprise a span of input values for which a valid output may be generated. For practical purposes, the maximum input range may be limited depending on available computing power. For example, for an 8-bit processor, the maximum input range may be from −128 to 127 for twos complement representation. The maximum input range may be from −127 to 127 with sign/magnitude. The maximum input range selected may be in the form of 2^{k}−1. Referring to FIG. 1, a maximum input range may be selected on each of the positive side and the negative side of the parabola 104 for the function y=x². The maximum input range may be divided into a plurality of segments depending on the accuracy of the approximation method used. For example, in FIG. 1, the piecewise linear approximation of the parabola 106 for the function y=x² may be obtained by dividing the positive side into a plurality of segments, for example, seven segments and the negative side into a plurality of segments, for example, seven segments. The first segment 108 may be obtained by dividing the maximum positive input range into half. For example, the first segment 108 may comprise values in the range 128 to 255. The second segment 110 may be obtained by dividing the remainder of the maximum input range into half. For example, the second segment 110 may comprise values in the range 64 to 127. The third segment 112 may be obtained by dividing the remainder of the maximum input range excluding segments 108 and 110 into half and so on. For example, the third segment 112 may comprise values in the range 32 to 63. The piecewise linear approximation of the parabola 106 for the function y=x² may be obtained by continuously dividing the subsequent remaining segments into half, for example, until they are reasonably close to 0. If the maximum input range selected is not in the form of 2^{k}−1, the largest linear segment may be utilized partially. The boundaries between the segments may be determined by the points where the slope changes. The slope of the segments may change at a power of 2 number. As a result, the transition points between the linear segments are the power of 2 numbers.

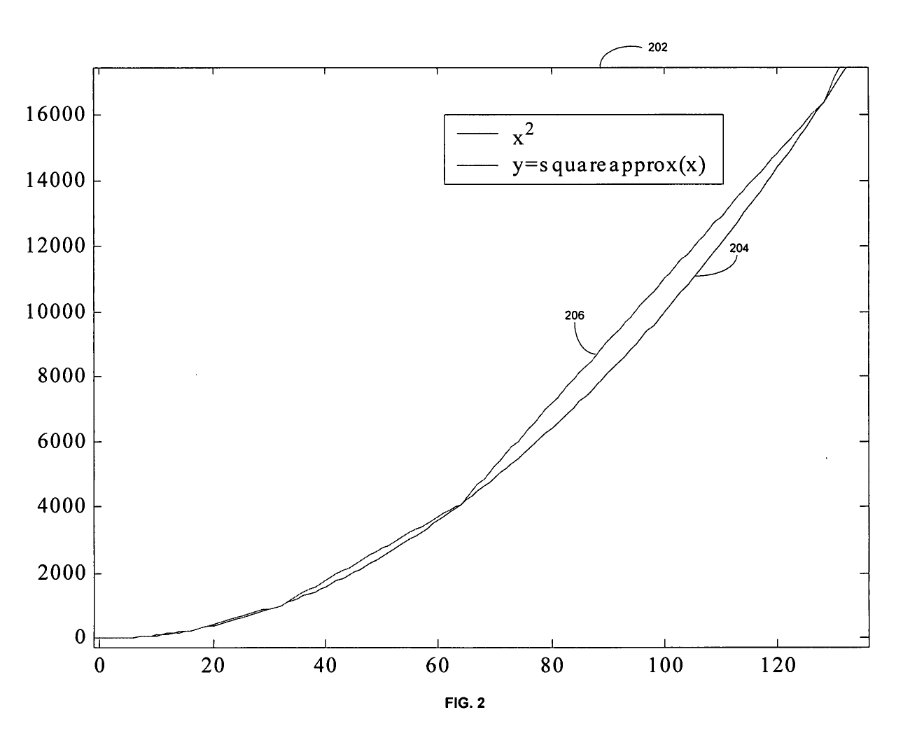

FIG. 2 is a graph 202 illustrating the positive half of the parabola 204 for the function y=x² and the positive half of the piecewise linear approximation of the parabola 206 for the function y=x² that may be utilized in connection with an embodiment of the invention. Referring to FIG. 2, the piecewise linear approximation of the parabola 206 for the function y=x² may be obtained as illustrated in FIG. 1.

Referring to FIG. 2, a maximum input range may be selected on the positive side of the parabola 204 for the function y=x². The maximum input range may be divided into a plurality of segments depending on the accuracy of the approximation method used. For example, for an 8-bit processor, the maximum input range may be from −128 to 127 for twos complement representation. The maximum input range may be from −127 to 127 with sign/magnitude. The maximum input range selected may be in the form of 2^{k}−1. For example, in FIG. 2, the piecewise linear approximation of the parabola 206 for the function y=x² may be obtained by dividing the positive side into a plurality of segments, for example, seven segments. The first segment 208 may be obtained by dividing the maximum positive input range into half. For example, the first segment 108 may comprise values in the range 128 to 255. The second segment 210 may be obtained by dividing the remainder of the maximum input range into half. For example, the second segment 110 may comprise values in the range 64 to 127. The third segment 212 may be obtained by dividing the remainder of the maximum input range excluding segments 208 and 210 into half and so on. For example, the third segment 112 may comprise values in the range 32 to 63. The piecewise linear approximation of the parabola 206 for the function y=x² may be obtained by continuously dividing the subsequent remaining segments into half, for example, until they are reasonably close to 0. If the maximum input range selected is not in the form of 2^{k}−1 the largest linear segment may be utilized partially. The boundaries between the segments may be determined by the points where the slope changes. The slope of the segments may change at a power of 2 number. As a result, the transition points between the linear segments are the power of 2 numbers.

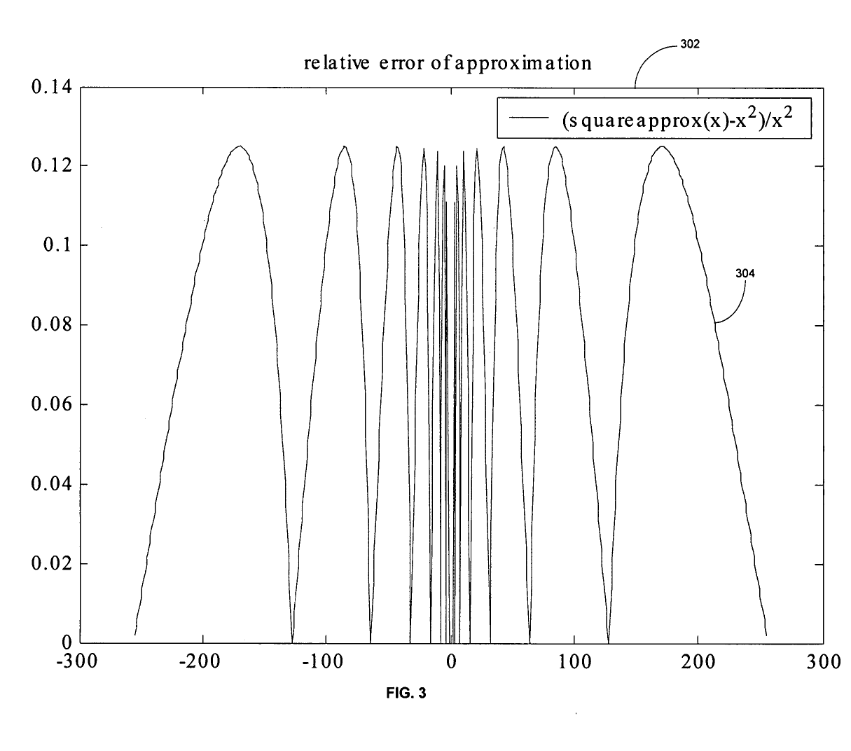

FIG. 3 is a graph 302 illustrating the relative error of approximation 304 between the parabola 104 (FIG. 1) for the function y=x² and a piecewise linear approximation of the parabola 106 for the function y=x² that may be utilized in connection with an embodiment of the invention. Referring to FIG. 3, there is shown the relative error of approximation 304, which may be calculated according to the following equation:

$$Relative error of approximation = \frac{( squareapprox ( x ) - {x}^{2} )}{{x}^{2}}$$

where squareapprox(x) is the piecewise linear approximation of the parabola 106 for the function y=x². The relative error of approximation 304 indicates a positive error of around 12%, for example. When using the piecewise linear approximation method to calculate Euclidean distances in the Viterbi algorithm, for example, a constant scaling factor may be utilized and the error of approximation may be within a range of +/−6%, for example.

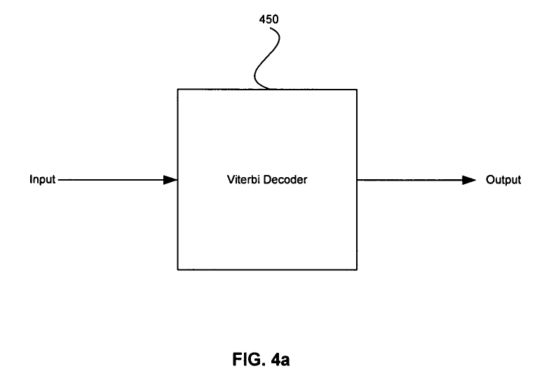

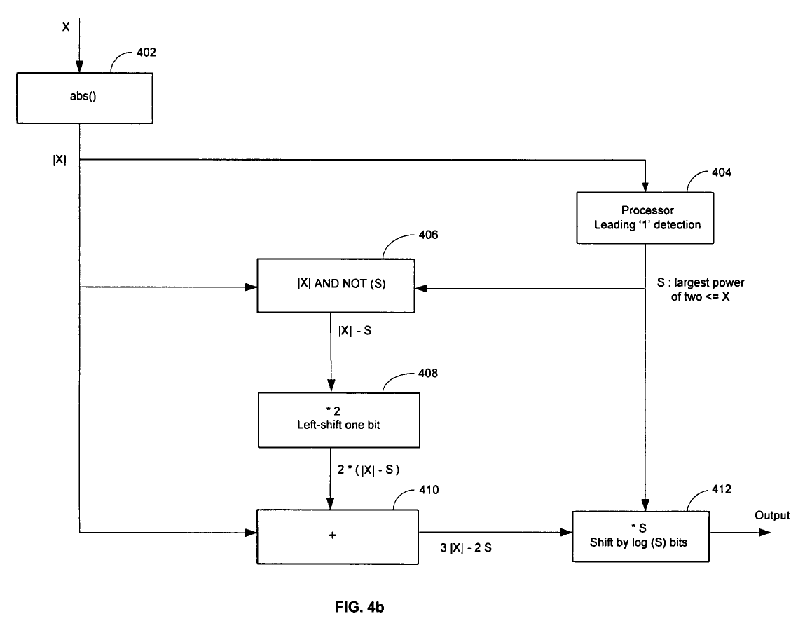

FIG. 4a is a block diagram illustrating an exemplary receiver comprising a Viterbi decoder that may utilize square function approximation, in accordance with an embodiment of the invention. The Viterbi decoder 450, which may also be referred to as an inner decoder, may comprise suitable logic, circuitry, and/or code that may be adapted to provide a first decoding of the data received. When doing square approximations, the Viterbi decoder 450 may determine Euclidean distances in branch metric calculations of the Viterbi algorithm. In an embodiment of the invention, the Viterbi decoder 450 may utilize, for example, a square approximation block to calculate the Euclidean distance for soft-decision decoding between a received code word and a plurality of possible transmitted code words. In certain instances, the decoding rate, the decoder's length constraint, and/or the puncturer rate of the Viterbi decoder 450 may be configurable.

Using the square function approximation provided in accordance with the various embodiment of the invention, the Viterbi decoder 450 may decode an input data stream from a demapper and an outer decoder may decode the output data stream from the Viterbi decoder 450. In this regard, the Viterbi decoder 450 and the outer decoder may perform decoding operations that correspond to the encoding operations performed by the corresponding encoders on the transmit side. The output of the outer decoder may correspond to the received data.

FIG. 4b is a block diagram illustrating an implementation of the piecewise linear approximation of the parabola for the function y=x², in accordance with an embodiment of the invention. Referring to FIG. 4b, there is shown a absolute value function block 402, a processor 404, an AND gate 406, a shifter block 408, an adder block 410, and a shifter block 412.

The absolute value function block 402 may comprise suitable logic and/or circuitry that may be adapted to receive the input X and generate an absolute value of X, |X| as its output. The processor 404 may comprise suitable logic and/or circuitry that may be adapted to determine the largest power of 2 less than or equal to the received number. The processor 404 may be adapted to detect a leading one ‘1’ in a plurality of received bits and generate an output with the leading one ‘1’ as its most significant bit (MSB) and adding zeros ‘0’ to the remaining bits. For example, if the received number is 130 with a binary representation of 10000010, the processor 404 may be adapted to detect the leading one ‘1’ in the MSB and add zeros ‘0’ to the remaining bits. For this example, the output of the processor 404 is 128 with a binary representation of 10000000, for example. The output S of the processor 404 for an input X may be mathematically represented according to the following equation:
S=2^{└log}^{₂}^{X┘} (1)

The AND gate 406 may comprise suitable logic and/or circuitry that may be adapted to receive a plurality of inputs and generate an output based on AND logic. The shifter blocks 408 and 412 may comprise suitable logic and/or circuitry that may be adapted to left-shift or shift at least one or more bits. The adder block 410 may comprise suitable logic and/or circuitry that may be adapted to add a plurality of received inputs and generate an output.

In operation, the absolute value function block 402 may receive an input X and generate an output |X|. The processor 404 may receive |X| from the absolute value function block 402 and generate an output S according to (1). The AND gate 406 may be adapted to receive |X| from the absolute value function block 402 and a logical NOT of S from the processor 404. The AND gate 406 may be adapted to generate an output |X|−S to the shifter block 408. The shifter block 408 may be adapted to receive |X|−S from the AND gate 406 and left shift one bit. The shifter block 408 may generate an output 2*(|X|−S) to the adder block 410. The process of left-shifting a value by one bit is equivalent to multiplying the value by 2. The adder block 410 may be adapted to receive |X| from the absolute value function block 402 and 2*(|X|−S) from the shifter block 408 and generate an output 3|X|−2S to the shifter block 412. The shifter block 412 may be adapted to left-shift the received input 3|X|−2S by log₂(S) bits. The process of left-shifting a value by log₂S bits is equivalent to multiplying the value by S. The shifter block 412 may be adapted to generate an output y=(3|X|−2S)*S which is an approximation of the function y=x².

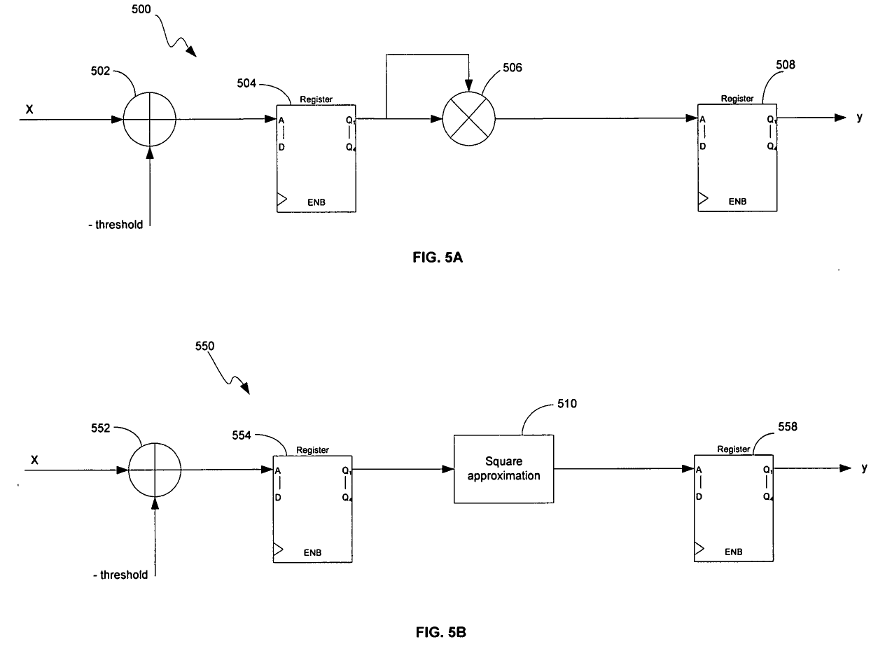

FIG. 5a is a block diagram illustrating implementation of the function y=x² that may be utilized in connection with an embodiment of the invention. Referring to FIG. 5a, there is shown an adder 502, a plurality of registers 504 and 508, and a multiplier 506. The adder 502 may comprise suitable logic and/or circuitry that may be adapted to add a plurality of received inputs and generate an output. The plurality of registers 504 and 508 suitable logic and/or circuitry that may be adapted to receive, hold and/or transfer bits of information, for example. The multiplier 506 may be adapted to multiply a plurality of received inputs and generate an output.

In operation, the adder 502 may be adapted to receive a plurality of inputs, X and a negated value of threshold, for example, and generate an output (X−threshold) to the register 504. For example, in the Viterbi algorithm, the linear distance between X and the threshold may be equal to the Euclidean distance to be determined. The multiplier 506 may be adapted to multiply the input by itself to generate an output y that is equal to the square of the input (X−threshold). The cell area required to implement the architecture represented in FIG. 5a to calculate the square of a function may be around 1224 μm², for example.

FIG. 5b is a block diagram illustrating implementation of an approximation of the function y=x², in accordance with an embodiment of the invention. Referring to FIG. 5b, there is shown an adder 552, a plurality of registers 554 and 558, and a square approximation block 510. The square approximation block 510 may be substantially as described in FIG. 4b. The adder 552 may comprise suitable logic and/or circuitry that may be adapted to add a plurality of received inputs and generate an output. The plurality of registers 554 and 558 suitable logic and/or circuitry that may be adapted to receive, hold and transfer bits of information, for example. The square approximation block 510 may comprise a absolute value function block 402 (FIG. 4b), a processor 404, an AND gate 406, a shifter block 408, an adder block 410, and a shifter block 412.

In operation, the adder 552 may be adapted to receive a plurality of inputs, X and a negated value of threshold, for example, and generate an output (X−threshold) to the register 554. For example, in the Viterbi algorithm, the linear distance between X and the threshold may be equal to the Euclidean distance to be determined. The absolute value function block 402 in the square approximation block 510 may receive an input (X−threshold) and generate an output |X−threshold|. The processor 404 in the square approximation block 510 may receive |X−threshold| from the absolute value function block 402 and generate an output S according to the following equation:
S=2^{└log}^{₂}(X−threshold)┘ (2)

The AND gate 406 in the square approximation block 510 may be adapted to receive |X−threshold| from the absolute value function block 402 and a logical NOT of S from the processor 404. The AND gate 406 in the square approximation block 510 may be adapted to generate an output |X−threshold|−S to the shifter block 408. The shifter block 408 in the square approximation block 510 may be adapted to receive |X−threshold|−S from the AND gate 406 and left shift one bit. The shifter block 408 may generate an output 2*(|X−threshold|−S) to the adder block 410. The process of left-shifting a value by one bit is equivalent to multiplying the value by 2. The adder block 410 in the square approximation block 510 may be adapted to receive |X−threshold| from the absolute value function block 402 and 2*(|X−threshold|−S) from the shifter block 408 and generate an output 3|X−threshold|−2S to the shifter block 412. The shifter block 412 in the square approximation block 510 may be adapted to left-shift the received input 3|X−threshold|−2S by log₂(S) bits. The process of left-shifting a value by log₂S bits is equivalent to multiplying the value by S. The shifter block 412 may be adapted to generate an output y=(3|X−threshold|−2S)*S which is an approximation of the function y=(X−threshold)².

The Viterbi algorithm may be utilized to perform the maximum likelihood decoding of convolutional codes. When a signal has no memory, a symbol-by-symbol detector may be utilized to minimize the probability of a symbol error. When a transmitted signal has memory, the signals transmitted in successive symbol intervals are interdependent. An optimum detector for a signal with memory may base its decisions on observation of a sequence of received signals over successive signal intervals. A maximum likelihood sequence detection algorithm may be adapted to search for the minimum Euclidean distance path through a trellis that characterizes the memory in the transmitted signal.

In a memoryless channel, a plurality of Hamming distances may be computed for hard-decision decoding and a plurality of Euclidean distances may be computed for soft-decision decoding between the received code word and a plurality of possible transmitted code words. The optimum decoding of a convolutional code may involve a search through the trellis for the most probable sequence. The corresponding metric in the trellis search may be either a Hamming metric or a Euclidean metric, depending on whether the detector following the demodulator performs hard or soft decisions respectively. In an embodiment of the invention, the square approximation block 510 may be adapted to calculate the Euclidean distance for soft-decision decoding between the received code word and a plurality of possible transmitted code words.

The Euclidean distances may be utilized for image classification. For example, an unknown pixel with feature vector X may be classified by assigning it to a class whose mean vector (M) is closest to X. A plurality of clusters may be approximated by N-dimensional spheres. In an embodiment of the invention, the square approximation block 510 may be adapted to calculate the Euclidean distance to classify an unknown pixel to a particular class in image classification.

The cell area required to implement the architecture represented in FIG. 5b to calculate the approximation of a square of a function might be around 889 μm², for example. There may be a 27% area savings in branch metric calculation of the Viterbi algorithm, for example. The branch metric unit (BMU) area may be around 40% of the soft output Viterbi algorithm (SOVA) implementation. A 10% area savings, for example, may be attained in the SOVA implementation by utilizing the square approximation block 510 with a negligible loss in decoder performance. Notwithstanding, embodiments of the invention may be utilized, where an approximation of a square function may be sufficient.

In another embodiment of the invention, the output wordlength may be reduced compared to the full wordlength of a square output by suitable reduction and simplification of hardware implementation of the approximation of the square function. For example, the square function of a 6 bit number may be a 11 bit or a 12 bit output number for a full square multiplication. In a custom application specific integrated circuit (ASIC), the lower 3-4 bits may be ignored without any significant change in the result, for example, resulting in reduced number of hardware requirements.

In an embodiment of the invention, a system for implementing a square function in a communication system may comprise at least one processor, for example, processor 404 that may be adapted to calculate a first value S from an absolute value of a first received input X. An AND gate 406 may be adapted to calculate a second value by ANDing the absolute value of the first received input, |X| and a negated value of the calculated first value S. In an embodiment of the invention, an adder or subtractor may be utilized to combine the absolute value of the first received input and the second received input S to generate the logical output value (|X|−S). The logical output value (|X|−S) may be generated by at least one of the following: logical ANDing the absolute value of the first received input and the value of the second received input, adding the absolute value of the first received input and the value of the second received input, and subtracting the absolute value of the first received input and the second received input. The value of the second received input may be a negated value of the second received input.

A first shifter, for example, shifter 408 may be adapted to calculate a third value 2*(|X|−S) by left-shifting the calculated second value (|X|−S) by at least one bit. An adder, for example, adder 410 may be adapted to calculate a fourth value (3|X|−2S) by adding the calculated third value 2*(|X|−S) with the absolute value of the received input, |X|. A second shifter, for example, shifter 412 may be adapted to generate an output y by left-shifting the calculated fourth value (3|X|−2S) by a plurality of bits.

The calculated first value S may be determined by S=2^{└log}^{₂}^{X┘}, where X is the first received input. The plurality of bits may be determined by log₂(S), where S is the calculated first value. The calculated first value, or the second received input S may be determined by detecting a leading ‘1’ in the absolute value of the first received input X. The generated output y may be determined by y=(3|X|−2S)*S, where |X| is the absolute value of the first received input and S is the calculated first value. The processor 404 may be adapted to utilize the generated output to determine Euclidean distances in branch metric calculation of Viterbi algorithm. The processor 404 may be adapted to utilize the generated output to determine Euclidean distances in image classification. For example, an unknown pixel with feature vector X may be classified by assigning it to a class whose mean vector (M) is closest to X.

Although the various embodiments of the invention are described with respect usage in Viterbi algorithm, the invention is not limited in this regard. Accordingly, the various embodiments of the invention may be utilized on other application such as to determine Euclidean distances in image classification. The various embodiments of the invention may be implemented using circuitry integrated on at least one integrated circuit or chip. The exemplary circuitry may comprise a generalized processor, a specialized processor such as a DSP or an ASIC, or a decoder.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for implementing an approximation function, the method comprising:
generating a logical output value from an absolute value of a first received input and a value of a second received input;
left shifting said generated logical output value to generate a left shifted value; and
generating an output by left shifting by a plurality of bits, a sum of the following: said generated left shifted value and said absolute value of said first received input.

2. The method according to claim 1, wherein said second received input denoted as S, is determined by S=2^{└log}^{₂}^{X┘}, where X is said first received input.

3. The method according to claim 1, wherein said plurality of bits is determined by log₂(S), where S is said second received input and S is determined by S=2^{└log}^{₂}^{X┘}, where X is said first received input.

4. The method according to claim 1, further comprising detecting a leading ‘1’ as a most significant bit in said first received input in order to generate said second received input.

5. The method according to claim 1, further comprising generating said output by (3|X|−2S)*S, where |X| is said absolute value of said first received input and S is said second received input and S is determined by S=2^{└log}^{₂}^{X┘}, where X is said first received input.

6. The method according to claim 1, further comprising determining Euclidean distances in Viterbi branch metric calculations utilizing said generated output.

7. The method according to claim 1, further comprising determining Euclidean distances in image classification utilizing said generated output.

8. The method according to claim 1, wherein said logical output value is generated by at least one of the following: logical ANDing, adding and subtracting, said absolute value of said first received input and said value of said second received input.

9. The method according to claim 1, wherein said value of said second received input is a negated value of said second received input.

10. A machine-readable storage having stored thereon, a computer program having at least one code section for implementing an approximation function in a communication system, the at least one code section being executable by a machine for causing the machine to perform steps comprising:
generating a logical output value from an absolute value of a first received input and a value of a second received input;
left shifting said generated logical output value to generate a left shifted value; and
generating an output by left shifting by a plurality of bits, a sum of the following: said generated left shifted value and said absolute value of said first received input.

11. The machine-readable storage according to claim 10, wherein said second received input denoted as S, is determined by S=2^{└log}^{₂}^{X┘}, where X is said first received input.

12. The machine-readable storage according to claim 10, wherein said plurality of bits is determined by log₂(S), where S is said second received input and S is determined by S=2^{└log}^{₂}^{X┘}, where X is said first received input.

13. The machine-readable storage according to claim 10, further comprising code for detecting a leading ‘1’ as a most significant bit in said first received input in order to generate said second received input.

14. The machine-readable storage according to claim 10, further comprising code for generating said output by (3|X|−2S)*S, where |X| is said absolute value of said first received input and S is said second received input and S is determined by S=2^{└log}^{₂}^{X┘}, where X is said first received input.

15. The machine-readable storage according to claim 10, further comprising code for determining Euclidean distances in Viterbi branch metric calculations utilizing said generated output.

16. The machine-readable storage according to claim 10, further comprising code for determining Euclidean distances in image classification utilizing said generated output.

17. The machine-readable storage according to claim 10, wherein said logical output value is generated by at least one of the following: logical ANDing, adding and subtracting, said absolute value of said first received input and said value of said second received input.

18. The machine-readable storage according to claim 10, wherein said value of said second received input is a negated value of said second received input.

19. A system for implementing a square function in a communication system, the system comprising:
circuitry that generates a logical output value from an absolute value of a first received input and a value of said second received input;
said circuitry left shifts said generated logical output value to generate a left shifted value; and
said circuitry generates an output by left shifting by a plurality of bits, a sum of the following: said generated left shifted value and said absolute value of said first received input.

20. The system according to claim 19, wherein said second received input, denoted as S, is determined by S=2^{└log}^{₂}^{X┘}, where X is said first received input.

21. The system according to claim 19, wherein said plurality of bits is determined by log₂(S), where S is said second received input and S is determined by S=2^{└log}^{₂}^{X┘}, where X is said first received input.

22. The system according to claim 19, wherein said circuitry detects a leading ‘1’ as a most significant bit in said first received input in order to generate said second received input.

23. The system according to claim 19, wherein said circuitry generates said output by (3|X|−2S)*S, where |X| is said absolute value of said first received input and S is said second received input and S is determined by S=2^{└log}^{₂}^{X┘}, where X is said first received input.

24. The system according to claim 19, wherein said circuitry determines Euclidean distances in Viterbi branch metric calculations utilizing said generated output.

25. The system according to claim 19, wherein said circuitry determines Euclidean distances in image classification utilizing said generated output.

26. The system according to claim 19, wherein said logical output value is generated by at least one of the following: logical ANDing, adding and subtracting, said absolute value of said first received input and said value of said second received input.

27. The system according to claim 19, wherein said value of said second received input is a negated value of said second received input.
